(19) United States
(12) Patent Application Publication
(10) Pub. No.: US 2023/0152004 A1
(43) Pub. Date: May 18, 2023

(54) HOT WATER STORAGE SYSTEM

(71) Applicant: TRUMA GERAETECHNIK GMBH & CO. KG, Putzbrunn (DE)

(72) Inventor: Bernhard STAHL, Putzbrunn (DE)

(21) Appl. No.: 17/995,889

(22) PCT Filed: Apr. 26, 2021
(86) PCT No.: PCT/EP2021/060857

§ 371 Date: Oct. 10, 2022

(30) Foreign Application Priority Data
May 7, 2020 (DE) 10 2020 112 355.8

(51) Int. Cl. F24H 1/08; F24H 1/00; G05D 16/20

(52) U.S. Cl. CPC F24H 1/08; F24H 1/009; G05D 16/2013

(57) ABSTRACT

The invention relates to a hot water storage system, in particular for mobile applications, comprising a water reservoir (6), a pump (10), a heat exchanger (20) and a hot water storage tank (40), characterized in that the hot water storage tank (40) has a variable storage volume and in that a drain line (60) is provided which connects the hot water storage tank (40) to the water reservoir (6).

### FIELD OF DISCLOSURE

The present disclosure relates to a hot water storage system, in particular for mobile applications, comprising a water reservoir, a pump, a heat exchanger and a hot water storage tank.

Such a hot water storage system can be used where the heat output of a heat exchanger is insufficient to provide hot water with the desired volume flow. Such heat exchangers are usually capable of heating a certain volume flow to a desired temperature. If hot water is to be withdrawn at a volume flow greater than that volume flow which can be heated to the desired temperature by means of the heat exchanger, part of the hot water is withdrawn from the hot water storage tank. This hot water storage tank contains a volume of water which has already been brought to the desired temperature.

Such hot water storage systems can be used in particular in mobile applications, for example in motor homes, camping trailers or boats.

### BACKGROUND

Typically, in the prior art, the hot water storage tank is used as a stratified storage tank, i.e., a water storage tank in which a temperature gradient is formed due to the different densities of water at different temperatures; the temperature of the water in the upper area of the hot water storage tank is higher than at the bottom. The hot water is withdrawn from the top of the hot water storage tank, so that if the water reserve in the hot water storage tank is heated in response to a user request, hot water is available there relatively quickly before the entire water reserve in the hot water storage tank has been heated.

However, in mobile applications, there is a risk that the thermal stratification of the water will be quickly disturbed by the movement of the vehicle. In addition, the hot water storage tank must have a certain volume and also a certain overall height so that a pronounced thermal stratification can form at all.

If it is not possible to reliably create the thermal stratification in the hot water storage tank, all the water contained therein must be heated so that a user can extract the desired hot water. In addition, the heating must be significantly higher than the desired hot water withdrawal temperature, as a continuously decreasing mixed temperature is established in the storage tank during the withdrawal of hot water; the withdrawn hot water is replaced by cold water flowing in simultaneously. Therefore, the temperature of the withdrawn water continuously decreases during the withdrawal.

After the withdrawal process, water remains in the hot water storage tank which has been heated at least to the desired withdrawal temperature, but cannot be used further, as the temperature would drop below the desired temperature (due to mixing with cold water) during further withdrawal.

The drawbacks of the prior art can therefore be summarized as follows: First, there is an unnecessarily high energy consumption, since water that cannot be used must be heated. Furthermore, a long lead time is required before the hot water is withdrawn, as an unnecessarily large amount of water has to be heated. There is also a strongly fluctuating withdrawal temperature of the hot water due to the cold water flowing in simultaneously. After the mixing temperature in the storage tank has dropped, even small amounts of water can only be withdrawn at a lower temperature than desired. A high weight of the hot water storage tank is also produced, because it is always filled with unusable water. The risk of legionella proliferation in the hot water storage tank also arises as it slowly cools down when it is not used. Finally, there is the risk of frost damage if the hot water storage tank is not completely emptied in time when the outside temperatures are low.

### SUMMARY

The object of the invention is to create a hot water storage system which eliminates the drawbacks of the prior art.

To achieve this object, the invention provides, in a hot water storage system of the type initially mentioned, that the hot water storage tank has a variable storage volume and that a drain line is provided which connects the hot water storage tank to the water reservoir. The invention is based on the basic idea of filling the hot water storage tank with water only when the provision of hot water has been requested, more specifically with hot water. Accordingly, there is no cold water in the hot water storage tank which must first be heated. Water which has not been consumed after a hot water request is returned to the water reservoir via the drain line, so that no water remains in the hot water storage tank which gradually cools down.

A number of advantages are thus achieved.

The storage tank is lightweight during mobile applications (e.g., driving) because it is usually empty. The total weight of the water reservoir and the hot water storage system is therefore comparatively low. In addition, the hot water storage tank does not have to withstand temperatures higher than the desired hot water temperature, so it can be made of comparatively low-temperature-resistant materials.

As the storage tank never contains cold water, no cold water is mixed with hot water therein. Therefore, the hot water storage tank can be sized much smaller than a conventional storage tank in which a constant volume of water is stored; the hot water storage tank used in the system according to the invention need only store the actually desired withdrawal quantity and not a volume from which the desired quantity of hot water can be withdrawn, taking the mixing with cold water into account.

Furthermore, the lead time before the withdrawal of larger volumes of water is significantly smaller than with mixed water storage tanks, as only the amount of water which can actually be used is heated. Furthermore, the temperature of the hot water withdrawn remains almost constant.

Furthermore, the energy expenditure corresponds to the energy expenditure required to heat the actually usable amount of hot water, as it is not necessary to heat excess water which cannot be used.

If the request for hot water results in the hot water storage tank being completely emptied, a certain amount of water with the desired hot water temperature is then continuously available at a constant rate, corresponding to the volume flow which can be heated by means of the heat exchanger. Furthermore, the risk of frost damage is reduced as the storage tank is not filled with water when the hot water storage system is not in operation.

Finally, the risk of legionella proliferation is greatly reduced since there is no volume of water in the hot water storage tank which may stand for extended periods of time at germ-promoting temperatures and is not replaced.

According to one embodiment of the invention, it is provided that the drain line has a throttle. The throttle allows a continuous return flow from the hot water storage tank to the hot water reservoir without having to make any other mechanical arrangements for this purpose.

It may also be provided that the drain line includes a pressure reducer arranged upstream of the throttle. The pressure reducer can be used to set a continuous, pressure-independent drain flow from the hot water storage tank to the water reservoir.

It may also be provided that the drain line has a switchable valve to prevent a drain flow to the water reservoir in certain operating situations, for example for a predetermined period of several minutes after a request for hot water. When the predetermined time period has elapsed, the switchable valve is opened so that the hot water storage tank is automatically drained to the water reservoir.

To be able to optimally control the flow of water through the heat exchanger, a valve is preferably associated with the heat exchanger.

A temperature sensor may be associated with the valve, in particular a sensor for the temperature of a heat transfer medium downstream of the heat exchanger. This makes it possible to regulate the amount of water flowing through the heat exchanger such that the temperature of the water downstream of the heat exchanger is constant, in particular if the valve is a regulating valve driven depending on a signal from the temperature sensor.

Preferably, the control valve is arranged upstream of the heat exchanger. This results in good control behavior.

Preferably, a throttle is associated with the pump so that the maximum volume flow delivered into the hot water branch can be limited and a sufficient amount of water is also available in the cold water branch at all times.

The throttle may be a regulatable valve to better control the temperature of the water downstream of the heat exchanger. Alternatively or additionally, an overflow valve may be provided in one embodiment, which is arranged downstream of the throttle. The overflow valve, resulting for example from a regulating valve and an associated pressure sensor mounted upstream, provides a constant pressure difference across the throttle. This makes it possible to keep the volume flow of water flowing through the heat exchanger constant, even in view of a possibly changing pressure of the water in the hot water storage tank.

According to one configuration of the invention, it is provided that the control valve is regulated depending on the pressure sensor.

Preferably, a valve unit is provided between the heat exchanger and the hot water storage tank by means of which it is controlled how the hot water storage tank is filled with hot water.

The valve unit may include a switching valve and a check valve connected in parallel therewith, the check valve allowing a flow from the hot water storage tank towards the heat exchanger. To fill the hot water storage tank, the switching valve is opened. If the pump is on at the same time (and no hot water is withdrawn from the system), the hot water storage tank is filled with hot water. If more hot water is withdrawn from the system than can be provided by the heat exchanger at the desired temperature, water will automatically flow in from the hot water storage tank via the check valve.

The hot water storage tank can have a pressure-dependent characteristic curve of stored water volume versus storage pressure, in particular such that the slope of the characteristic curve increases sharply shortly before the maximum storage volume is reached. This enables a constant flow through the heat exchanger and thus a constant hot water temperature when the hot water storage tank is filled, especially in conjunction with a flow-limiting throttle or a throttle valve. When the storage tank pressure approaches the maximum value, the water flow stops abruptly and without gradual temperature change due to the steeply rising characteristic curve.

The hot water storage tank may be a membrane storage tank, as is generally known from equalization tanks suitable for drinking water. However, it is important to note that the membrane here is not merely designed to compensate for fluctuations in the fill level of a system, but is designed to allow the hot water storage tank to be completely drained.

Preferably, it is provided that the drain line is connected to the hot water storage tank in the vicinity of the membrane. The amount of water which has already been in the hot water storage tank the longest is thus first returned to the water reservoir.

The hot water storage tank may also be a bellows storage tank or a bladder storage tank. More important than the specific structural configuration is that the hot water storage tank is designed to be (at least substantially) completely drained when not filled with hot water by the hot water storage system in response to a hot water request from an operator.

According to one configuration of the invention, a gas cushion is provided to pressurize the volume of hot water contained in the hot water storage tank. Such a hot water storage tank is characterized by a structurally simple design.

It may also be provided that the volume of hot water contained in the hot water storage tank is mechanically pressurized, in particular by means of a spring or a motor. This allows the characteristic curve of stored water volume versus storage pressure to be set in the desired manner.

A fluid may also be provided which pressurizes the hot water volume contained in the hot water storage tank. This can be cold water, for example, which provides the desired pressure. In this way, a pressure characteristic of the hot water storage tank dependent on the storage volume can be avoided, which makes it possible to fill the hot water storage tank with a constant volume flow (constant temperature) with less effort.

It may also be provided that the hot water storage tank is an open storage tank, from which the received hot water flows solely under the effect of gravity either to a hot water withdrawal point or via the drain line to the water reservoir.

According to a configuration of the invention, a cold water withdrawal point is provided which is connected downstream of the pump, a flow control valve or a pressure reducer being arranged between the cold water withdrawal point and the pump. By means of the pressure reducer, the flow through the cold water branch can be set to a constant value so that the admission pressure of a water tap at which the cold water branch and the hot water branch are mixed is at a constant value, resulting in constant flows and temperatures.

Such a pressure reducer may also be provided at the hot water withdrawal point to set a constant volume flow.

The volume of the hot water storage tank may in particular be between 3 l and 10 l, particularly preferably between 4 l and 6 l. These values have been found to be a good compromise between good availability of a high quantity of hot water on the one hand and acceptable dimensions on the other hand.

### BRIEF DESCRIPTION OF DRAWINGS

The invention will be described below with reference to various embodiments which are illustrated in the accompanying drawings, in which:

FIG. 1 shows a schematic view of a hot water storage system according to a first embodiment of the invention;

FIG. 2 shows a schematic view of a hot water storage tank which can be used in a hot water storage system according to the invention;

FIG. 3 shows a detailed view of a variant embodiment of the first embodiment;

FIGS. 4 to 9 show alternative configurations of hot water storage tanks which can be used in a hot water storage system according to the invention; and

FIG. 10 shows a schematic representation of a hot water storage system according to a further embodiment of the invention.

### DETAILED DESCRIPTION OF EXAMPLE EMBODIMENTS

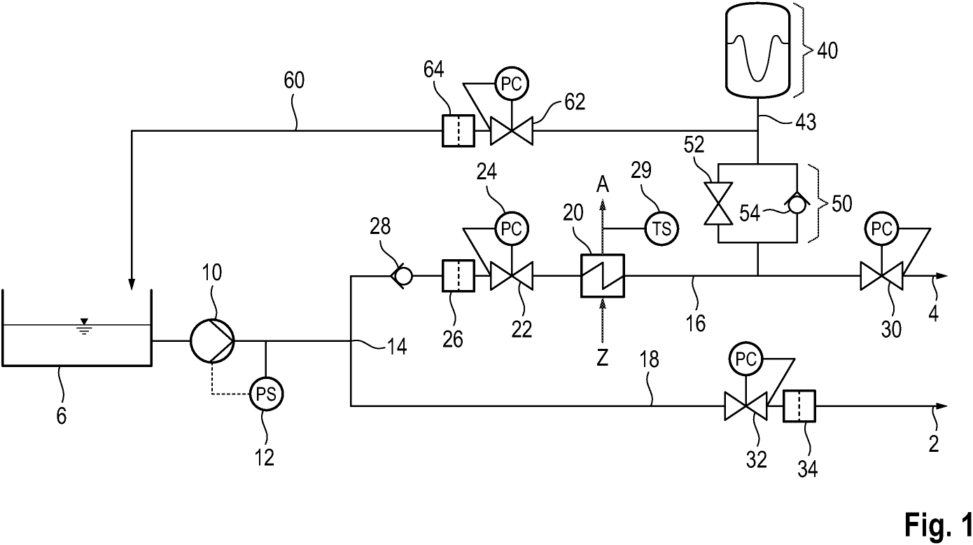

FIG. 1 schematically shows a hot water storage system according to a first embodiment. It serves to provide water at a desired temperature to a user at a cold water withdrawal point 2 and a hot water withdrawal point 4. The water originates from a water reservoir 6. The water withdrawal points 2, 4 may be, for example, separate water taps. It is also possible that the water withdrawal points are combined in a common water tap, for example a mixer tap, to extract a volume of water with a temperature which can be set to a desired value by mixing the volume flows of cold water and hot water.

The hot water storage system may also have more than one cold water withdrawal point 2 and more than one hot water withdrawal point 4.

The hot water storage system is intended here in particular for mobile applications, for example for motor homes or camping trailers. It can also be used for pleasure boats, etc. Accordingly, the water reservoir typically has a volume on the order of a few dozen liters to a few hundred liters.

A pump 10 is provided to convey the water from the water reservoir to the withdrawal points. It can activate in a pressure-controlled manner. A pressure sensor 12 can be provided for this purpose.

Downstream of the pump 10, the system branches at a branching 14 into a hot water branch 16 and a cold water branch 18.

To heat the water withdrawn from the water reservoir 6, a heat exchanger 20 is provided in the hot water branch 16. It is of secondary importance for the function of the hot water storage system on which principle the heat exchanger 20 is based. The only decisive factor is that available energy is converted into heat such that water flowing through the heat exchanger 20 is heated. For example, the heat exchanger 20 may be part of a gas-fired heater. In this case, the arrow Z in FIG. 1 symbolizes a combustible gas, and the arrow A symbolizes the combustion gases leaving the heat exchanger 20. In particular, the combustion gases serve as a heat transfer medium the thermal energy of which is transferred to the water in the heat exchanger 20.

It is also possible that the heat exchanger 20 is part of an electrically powered heater. In this case, the arrow Z symbolizes the electrical energy supplied, and there would be no equivalent to the arrow A.

It is also possible that the heat exchanger 20 is part of a warm air system. In this case, the arrow Z in FIG. 1 symbolizes hot air and the arrow A symbolizes cooled air leaving the heat exchanger 20. In particular, the air serves as a heat transfer medium the thermal energy of which is transferred to the water in the heat exchanger 20.

A valve 22 is arranged here between the pump 10 and the heat exchanger 20 (and thus associated with the heat exchanger 20). “Associated” means here that the valve 22 is arranged downstream of the branching 14, in which the water line downstream of the pump 10 splits into a cold water branch and a hot water branch.

The valve 22 includes a pressure sensor 24 which senses the pressure upstream of the valve 22. The valve 22 can be operated as a regulating valve.

A throttle 26 in the form of an orifice plate is arranged upstream of the valve 22. Furthermore, a check valve 28 is provided, which allows a flow only in the direction from the pump 10 to the heat exchanger 20.

A temperature sensor 29 is associated with the heat exchanger 20, which terminates the operation of the heat exchanger 20 when there is no or insufficient heat removal by the water. In this way, overheating of the water in the heat exchanger 20 is prevented.

A pressure reducer 30 is provided downstream of the heat exchanger 20 and upstream of the hot water withdrawal point 4. It regulates the water pressure downstream of the pressure reducer 30 to a constant value.

A pressure reducer 32 is also arranged in the cold water branch 18, more specifically between the branching 14 towards the cold water branch 18 and the cold water withdrawal point 2. Furthermore, a throttle 34 is provided, which may contain an orifice plate, for example.

The hot water storage system has a hot water storage tank 40 connected to the hot water branch 16 downstream of the heat exchanger 20 and upstream of the pressure reducer 30. For this purpose, a valve unit 50 is provided herein which includes a switching valve 52 and a check valve 54 connected in parallel therewith.

The switching valve 52 can be used to open and close the connection of a line 43 from the hot water branch 16 to the hot water storage tank 40. The check valve 54 allows flow from the hot water storage tank 40 to the hot water branch 16 irrespective of the state of the switching valve 52.

A drain line 60 is provided by means of which the hot water storage tank 40 is connected to the water reservoir 6. In the example embodiment shown, the drain line 60 is connected between the valve unit 50 and the hot water storage tank 40. It is also possible to connect the drain line 60 directly to the hot water storage tank 40.

A switchable valve or a pressure reducer 62 is arranged in the drain line 60. A throttle 64, which may be designed as an orifice plate, for example, is arranged downstream of the pressure reducer 62.

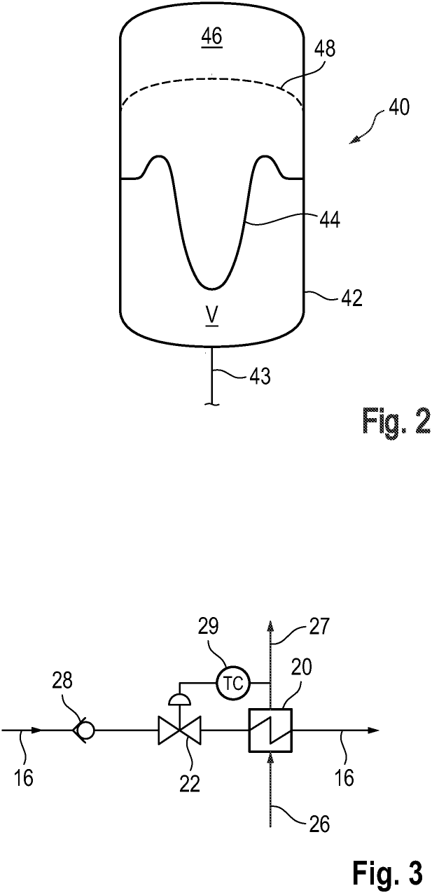

The hot water storage tank 40 (see in particular FIG. 2) has a mechanically stable envelope 42, which is connected to the valve unit 50 and the drain line 60 via a line 43. A flexible membrane 44 is arranged inside the envelope 42, below which a variable storage volume V for hot water is defined.

A gas cushion 46 which urges the flexible membrane 44 towards a minimum storage volume (ideally zero) is enclosed above the membrane 44.

Associated with the membrane 44 is a mechanical stop 48 for the membrane 44, such as a net, wire mesh, or similar limitation for the maximum upward expansion of the membrane 44.

Due to the elasticity of the membrane 44, the hot water storage tank 40 has a pressure-dependent characteristic curve of stored water volume versus storage pressure.

Due to the mechanical stop 48, the slope of the characteristic curve increases sharply shortly before the maximum storage volume is reached. In other words, as long as the expansion of the membrane 44 is not yet limited by the mechanical stop 48, the hot water storage tank acts similarly to a pressure equalization tank. However, once the membrane 44 is in contact with the mechanical stop 48, the hot water storage tank 40 acts similar to a completely filled tank.

When water is withdrawn from the cold water withdrawal point 2, the pressure sensor 12 registers that the water pressure is dropping. Then the pump 10 is switched on, and it delivers water from the water reservoir 6 via the cold water branch 18 to the cold water withdrawal point 2. The admission pressure of the tap can be stabilized there by means of the pressure reducer 32.

The throttle 34 arranged in the cold water branch 18 is useful if the maximum delivery rate of the pump 10 is not sufficient to supply the cold water withdrawal point 2 and the hot water withdrawal point 4 with sufficient flow rate at the same time. Thus, the maximum flow rate is limited to a value which allows water to still be withdrawn at an acceptable volume flow at the hot water withdrawal point 4 even when the cold water withdrawal point 2 is open.

When hot water is withdrawn at the hot water withdrawal point 4, two scenarios must be distinguished: A flow up to the maximum flow rate which can be heated to the desired temperature in the heat exchanger 20, and a flow rate above this limit.

With a flow rate up to the limit value, the water can be continuously heated to the desired temperature in the heat exchanger 20. It is only necessary to ensure, by suitable interaction of the pressure reducer 30, the pump 10, the throttle 26, and the control valve 22, that a flow rate as constant as possible is obtained at the hot water withdrawal point 4.

When a user knows that he or she will soon want to withdraw a larger amount of hot water (for example, to take a shower or quickly fill a sink), a preheating function is activated (for example, by actuating a switch or button), which essentially consists in filling the hot water storage tank 40 with hot water.

For this purpose, a preheat button may be actuated so that a controller suitably operates the hot water storage system. Alternatively, the user may open the switching valve 52 so that a heating operation is automatically initiated due to the change in pressure in the hot water branch 16.

It is also possible for the user to press the preheat button again, or to close the switching valve 52 prematurely, if only a smaller amount of hot water is to be provided in the hot water storage tank 40.

Generally speaking, to fill the hot water storage tank 40 with hot water, the heat exchanger 20 is operated and water is delivered from the water reservoir 6 by means of the pump 10. At the same time, the switching valve 52 is opened so that the hot water storage tank 40 is filled.

Depending on the configuration of the drain line 60, part of the filled water can already escape via the throttle 64 towards the water reservoir 6 during filling of the hot water storage tank 40. However, the amount of water that is lost to the water reservoir 6 in view of the pressure present in the water storage tank 40 is relatively small, so that this can be tolerated. It may also be provided that the valve 62 is kept closed as long as the hot water storage tank 40 is filled.

When the hot water storage tank 40 is completely filled, the pressure upstream of the pump 10 rises sharply, so that it is switched off due to a corresponding signal from the pressure sensor 12. At the same time, the operation of the heat exchanger 20 is also stopped, for example by a suitable control or by the temperature sensor 29 stopping the operation thereof because of the stopped heat withdrawal in the heat exchanger 20.

At the latest when the operation of the heat exchanger 20 has ended, the drain line 60 to the water reservoir 6 is opened so that the hot water storage tank 40 is slowly drained. This ensures that no water reserve, which is at a low temperature, stands there for a longer period of time.

Now, when the user extracts the hot water when the hot water storage tank 40 is charged, a volume flow can be withdrawn at the hot water withdrawal point 4, which consists partly of hot water stored in the hot water storage tank 40 and partly of water which is conveyed by the pump 10 through the heat exchanger 20, which is operated at the same time, and is thus heated.

When the hot water storage tank 40 is emptied, the check valve 28 ensures that the hot water cannot be forced back into the water reservoir 6 or reach the cold water withdrawal point 2.

Once the hot water storage tank 40 is completely drained, the available volume flow of hot water is reduced to the amount that can be continuously heated to the desired temperature in the heat exchanger 20.

If the drawing of hot water is terminated before the hot water storage tank 40 is completely emptied, the remaining water is continuously discharged to the water reservoir 6 via the drain line 60. The flow is thus dimensioned such that the hot water storage tank 40 is already drained before the temperature of the water therein has dropped significantly.

The valve 62 acts as a pressure reducer in the drain line 60, so that there is a constant differential pressure at the throttle 64 and thus a constant recirculation rate through the drain line 60 which is independent of the storage tank pressure.

In general, for the operation of the heat exchanger 20, it may be provided that it starts automatically as soon as the pump 10 (triggered by a signal from the pressure sensor 12) starts to deliver. At the same time, the switching valve 52 may be opened for a short period of time to ensure a certain minimum water flow through the heat exchanger 20.

When the user wishes to fill the hot water storage tank 40, the switching valve 52 is also automatically opened after the heat exchanger 20 is started, so that the hot water storage tank 40 is filled.

During operation of the heat exchanger 20, a constant water temperature at the outlet of the heat exchanger 20 is desirable. To obtain this, (assuming a constant power output to the water to be heated) the through-flow velocity of the water must also be nearly constant. However, the pressure in the hot water storage tank 40 is dependent on the level of the hot water storage tank 40 during both filling and emptying. In the following, it will be described how a flow rate independent of the storage tank pressure can nevertheless be realized.

The pump 10 may be set to have on and off points which differ by 0.2 bar, for example, such as a cut-in pressure of 3.5 bar and a cutoff pressure of 3.7 bar. Thus, the pump 10 provides a reasonably constant pressure of between 3.5 and 3.7 bar.

The throttle 26, together with the control valve 22, is designed to achieve the flow rate suitable for the heat exchanger 20 at a pressure difference of 0.3 to 0.5 bar. In this case, the control valve 22 regulates the pressure downstream of the throttle to a value of 3.2 bar, so that the latter is always operated at the design pressure difference regardless of the (lower) storage tank pressure. This works as long as the pressure downstream of the control valve 22 (i.e. the pressure of the hot water storage tank 40) is lower than the set value of 3.2 bar.

If the pressure downstream of the control valve 22 increases to a value greater than 3.2 bar, the flow rate decreases continuously until the pump completely stops the flow at 3.7 bar. During this period, the water temperature downstream of the heat exchanger 20 is slightly higher than the desired withdrawal temperature. However, due to the steeply rising characteristic curve of the pressure characteristic of the hot water storage tank 40, this period is comparatively short. The heat exchanger 20 is switched off by the temperature sensor 29 of the heat exchanger 20 at the latest when the pump 10 is switched off when the cutoff threshold of 3.7 bar is reached.

As soon as the water tap is opened at the hot water withdrawal point 4, the pressure downstream of the control valve 22 drops below a value of 3.5 bar. The pump 10 starts as soon as the pressure falls below the cut-in threshold of 3.5 bar - in particular when water is withdrawn or when the hot water storage tank 40 is filled. This causes water to be pumped through the heat exchanger 20 again.

In principle, it is also possible to configure the system more simply at this point and merely provide a suitably dimensioned throttle 26 in place of the control valve 22.

FIG. 3 describes a variant embodiment which can be used instead of the assembly composed of the control valve 22, the pressure sensor 24 and the throttle 26. The same reference numerals are used for the components known from FIG. 1, and reference is made to the above explanations.

In the variant of FIG. 3, when the heat exchanger 20 is put into operation, first the heat transfer medium in the heat exchanger 20 is cooled as heat is transferred to the water present in the heat exchanger 20. If there is no water flow in the heat exchanger 20, the water temperature rises, so that the temperature of the heat transfer medium A flowing out of the heat exchanger 20 also rises due to the falling temperature difference.

This is detected by the temperature sensor 29, which opens the control valve 22 (regardless of the pressure conditions) to the same extent so that the cold water flowing into the heat exchanger 20 keeps the temperature of the heat transfer medium at a constant value. If the temperature of the heat transfer medium A downstream of the heat exchanger 20 is constant, then (assuming a constant inlet temperature) the temperature of the water downstream of the heat exchanger 20 is also constant.

This regulation works even if initially no water flows through the heat exchanger 20. This would not be the case if the temperature were measured on the outlet side of the water at heat exchanger 20.

Temperature regulation can also be done electronically or using a thermostatic valve.

The safety shut-off function on the heat exchanger 20 to prevent overheating of the water therein is retained unchanged in this embodiment.

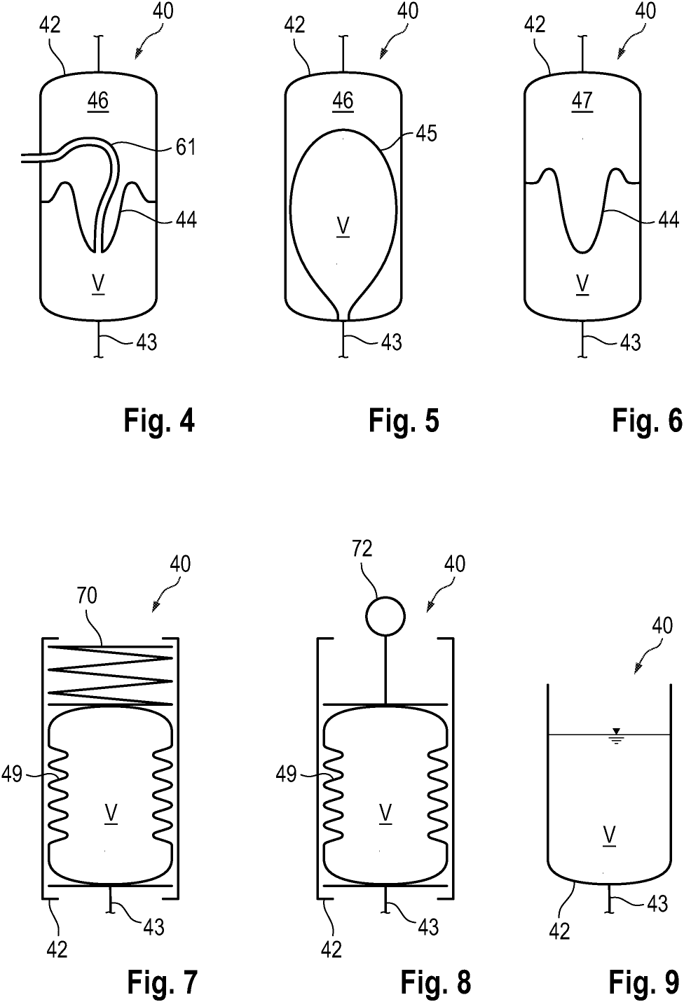

FIGS. 4 to 9 show various alternative designs of the hot water storage tank 40. The same reference numerals are used for the components known from FIG. 2, and in this respect, reference is made to the above explanations.

The embodiment of FIG. 4 differs from the embodiment of FIG. 1 in that the drain line 60 is here connected directly to the membrane 44 as a thin hose 61.

In the embodiment of FIG. 5, the volume V of hot water is enclosed in a bladder 45 which is pressurized by a gas cushion 46.

The embodiment of FIG. 6 differs from the previous ones in that instead of a gas pressure accumulator, a hydraulic membrane accumulator is realized, in which the space above the membrane 44 is urged by a liquid, for example cold water.

The embodiment according to FIG. 7 differs from the previous ones in that the volume V of hot water is contained in a bellows 49, which is mechanically urged in the direction of a minimum volume. Here, a spring 70 is used.

The embodiment of FIG. 8 differs from that according to FIG. 7 in that instead of the spring 70, either a motor 72 is provided which urges the bellows 49 mechanically in the direction of a small volume, or alternatively a weight which presses on the bellows 49.

FIG. 9 shows an embodiment in which the hot water storage tank 40 is configured as an open storage tank.

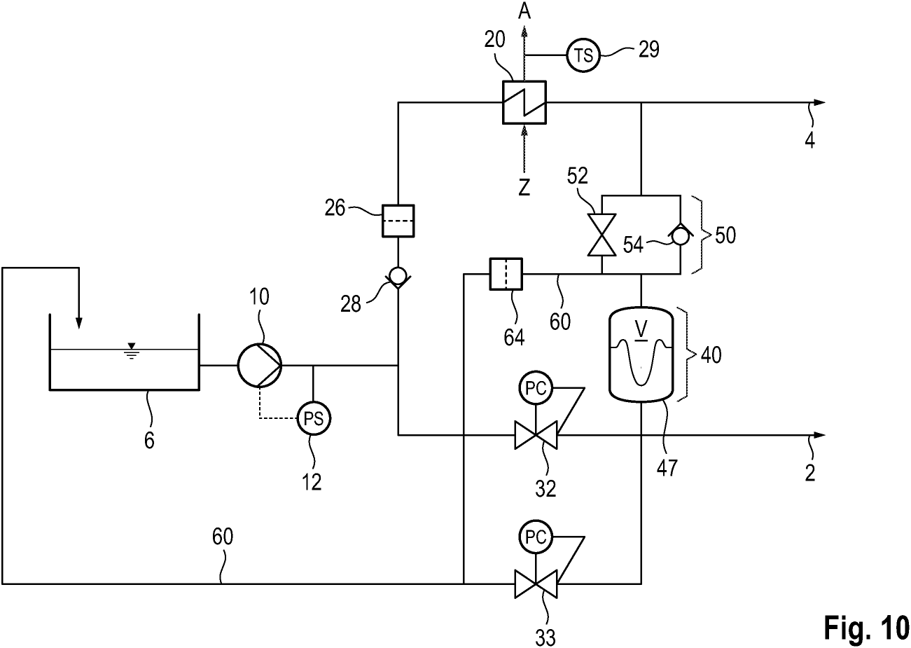

FIG. 10 shows a second embodiment of the hot water storage system. The same reference numerals are used for the components known from the first embodiment, and in this respect, reference is made to the above explanations.

The hot water storage tank 40 corresponds here to that shown in FIG. 6. Thus, a hydraulic hot water storage tank is involved here in which cold water is applied to the membrane 44 on the side opposite to the volume V.

In particular, the pressure of the hydraulic medium 47 in the hot water accumulator 40 can be kept substantially constant due to the pressure reducer 32 and the overflow valve 33 on the cold water side.

Since the pressure in the hot water storage tank 40 is substantially constant in the second embodiment, some components of the hot water storage system can be designed simpler.

One simplification is that instead of the control valve 22 used in the first embodiment, only a throttle 26 (along with a check valve 28) is required in the second embodiment.

A further simplification consists in that there is no pressure reducer 62 in the drain line 60, only the throttle 64.

The pressure reducer 30 present here represents a convenience function and is - as, for example, also in the embodiment of FIG. 1 - not absolutely necessary.

In the following, it will be explained with reference to one example which advantages result both for the preheating time and the energy expenditure if the hot water storage tank 40 according to the invention which has a variable storage volume is used instead of a water reservoir from the prior art in which a constant water volume is accommodated.

It is assumed that the cold water has a temperature of 15° C., that the water in the hot water storage tank 40 has a maximum temperature of 70°, and that the desired temperature of the hot water to be withdrawn at the hot water withdrawal point 4 is 40°. Furthermore, a withdrawal quantity of 3.5 l per minute and a desired withdrawal duration of 5 min is assumed. Furthermore, it is assumed that the heat exchanger is operated when the hot water is withdrawn and that it has a heating capacity of 2 kW.

The amount of water to be extracted in 5 min is 17.5 l. Accordingly, 510 Wh of energy is required to heat this amount of water. Since the heat exchanger 20 can supply an energy of 167 Wh during the operating time of 5 min, an energy of 343 Wh must be provided from the hot water storage tank.

A constant volume hot water storage tank must have a capacity of 9.8 l to supply the required amount of water at the desired temperature, starting from a maximum temperature of 70° C., before the temperature in the hot water storage tank has dropped to 40° C. Accordingly, an energy of 629 Wh is required, and a preheating time of 18.9 min is necessary.

A hot water storage tank 40 with variable storage volume only requires a storage volume of 5.4 l. This storage volume can be heated to the desired temperature with a preheating time of 10.3 min. This requires an energy of 343 Wh.

It can be seen that both the necessary amount of energy and the necessary preheating time are considerably less than what is required for a hot water storage tank with a constant volume.

1. A hot water storage system for mobile applications, comprising; a water reservoir, a pump, a heat exchanger and a hot water storage tank, wherein the hot water storage tank (40) has a variable storage volume and wherein a drain line is provided which connects the hot water storage tank (10) to the water reservoir.

2. The hot water storage system according to claim 1, wherein a valve is associated with the heat exchanger, a temperature sensor being associated with the valve, for a temperature of a heat transfer medium downstream of the heat exchanger, and the valve being a control valve driven depending on a signal from the temperature sensor.

3. The hot water storage system according to claim 2, wherein the control valve is arranged upstream of the heat exchanger.

4. The hot water storage system according to claim 1, wherein a throttle is associated with the pump, the throttle being a regulatable control valve and a pressure sensor being provided which is arranged upstream of the control valve.

5. The hot water storage system according to claim 4, wherein the control valve is regulated depending on the pressure sensor.

6. The hot water storage system according to claim 1, wherein a valve unit is provided between the heat exchanger and the hot water storage tank, the valve unit including a switching valve and a check valve connected in parallel therewith, the check valve allowing a flow from the hot water storage tank towards the heat exchanger.

7. The hot water storage system according to claim 1, wherein the hot water storage tank has a pressure-dependent characteristic curve of stored water volume versus storage tank pressure, the slope of the characteristic curve increasing sharply shortly before the maximum storage volume is reached.

8. The hot water storage system according to claim 1, wherein the hot water volume contained in the hot water storage tank is mechanically pressurized by at least one of a spring or a motor.

9. The hot water storage system according to claim 1, wherein a liquid pressurizing the hot water volume contained in the water storage tank is provided.

10. The hot water storage system according to claim 1, wherein the hot water storage tank is an open storage tank.

11. The hot water storage system according to claim 1, wherein a cold water withdrawal point is provided which is connected upstream of the pump, and wherein a pressure reducer is arranged between the cold water withdrawal point and the pump.

12. The hot water storage system according to claim 1, wherein a warm water withdrawal point is provided, which is connected downstream of the pump, and wherein a pressure reducer is arranged between the warm water withdrawal point and the pump.
